(19) United States
(12) Patent Application Publication
(10) Pub. No.: US 2009/0219905 A1
(43) Pub. Date: Sep. 3, 2009

(54) WIRELESS COMMUNICATION COLLISION DETECTION

(75) Inventors: Aamod D. Khandekar, San Diego, CA (US); Rajarshi Gupta, Santa Clara, CA (US); Ravi Palanki, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/395,230

(22) Filed: Feb. 27, 2009

Related U.S. Application Data
(60) Provisional application No. 61/033,322, filed on Mar. 3, 2008.

(51) Int. Cl. H04L 12/28; H04L 12/413

(52) U.S. Cl. 370/338; 370/445

(57) ABSTRACT

Collisions in a wireless network are detected and resolved through the use of transmissions by access points in the network. In some aspects, each access point may select a resource from a set of resources and transmit an indication of a unique identifier (e.g., a long identifier) of that access point on the selected resource. In some aspects, each access point may select a bit and append that bit to a reused identifier (e.g., a short identifier) of that access point to provide a channelization parameter that is used to channelize signals transmitted by the access point. The selection by a given access point may be based on a unique identifier assigned to that access point. The selection by a given access point may be a pseudorandom selection (e.g., based on a corresponding unique identifier). Another node (e.g., an access terminal) in the network may identify a collision based on the transmissions by the access points. In this case, the node may transmit an indication of the collision to cause one of the access points to cease transmitting. The node may then inform one colliding access point of the existence and identity of the other colliding access point to enable the access points to resolve the collision.

### CLAIM OF PRIORITY

This application claims the benefit of and priority to commonly owned U.S. Provisional Patent Application No. 61/033,322, filed Mar. 3, 2008, and assigned Attorney Docket No. 080879P1, the disclosure of which is hereby incorporated by reference herein.

### BACKGROUND

1. Field

This application relates generally to wireless communication and more specifically, but not exclusively, to collision detection.

2. Introduction

Wireless communication systems are widely deployed to provide various types of communication (e.g., voice, data, multimedia services, etc.) to multiple users. As the demand for high-rate and multimedia data services rapidly grows, there lies a challenge to implement efficient and robust communication systems with enhanced performance.

To supplement conventional mobile phone network access points, small-coverage access points may be deployed (e.g., installed in a user's home) to provide more robust indoor wireless coverage to mobile units. Such small-coverage access points are generally known as access point base stations, Home NodeBs, Home eNodeBs, pico cells, or femto cells. Typically, such small-coverage access points are connected to the Internet and the mobile operator's network via a DSL router or a cable modem.

In a conventional wireless network, each access point (e.g., each sector or cell) is assigned a long identifier which may be referred to as, for example, a global cell identifier (“GCI”), a sector identifier (“SectorID”), an access node identifier (“ANID”), or as some other type of identifier. Additionally, each access point may be assigned a short identifier, which may be referred to as, for example, a physical cell identifier (“PCI”), a pilot pseudorandom number (“PilotPN”), or as some other type of identifier. The short identifier may be used to modulate physical layer channels. Since this identifier is relatively short, an access terminal may be able to efficiently search for a waveform, such as a time division multiplexed (“TDM”) pilot, corresponding to that short identifier. This helps the access terminal identify the sectors in its vicinity and demodulate their transmissions, which also may be scrambled by the short identifier.

Typically, the space allocated for the short identifiers is relatively limited. Consequently, it is desirable for a network operator to ensure that the same short identifier is not used by access points that are relatively close to each other to avoid so-called collisions between communications of neighboring access points. While this is feasible in a traditional planned network, it may not be feasible in an unplanned or ad-hoc network (e.g., a network employing many small-coverage access points). In an ad-hoc network, the network operator or a customer may deploy an access point without knowing which short identifier should be used to ensure that collisions never occur (if collisions are indeed entirely avoidable). Thus, there is a need for effective techniques for detecting and resolving collisions in wireless networks.

### SUMMARY

A summary of sample aspects of the disclosure follows. It should be understood that any reference to the term aspects herein may refer to one or more aspects of the disclosure.

The disclosure relates in some aspect to detecting a collision in a wireless network and resolving the collision. In some aspects, access points may transmit signals (e.g., in a pseudorandom manner or some other manner) to enable another node to identify collisions between the access points. For example, in some implementations each access point may select (e.g., pseudorandomly select) a resource from a set of resources and transmit an indication of a unique identifier (e.g., a long identifier) of that access point on the selected resource. In some implementations each access point may select (e.g., pseudorandomly select) a bit and append that bit to a reused identifier (e.g., a short identifier) of that access point to provide a channelization parameter that is used to channelize signals transmitted by the access point. In some aspects the selection by a given access point may be based on a unique identifier assigned to that access point.

In the event another node (e.g., an access terminal) identifies a collision, this collision identifying node may transmit an indication of the collision in an attempt to cause a colliding access point to cease transmitting on at least one resource. In some aspects, the collision identifying node may transmit such an indication over a channel that is dedicated for collision reporting.

Once a colliding access point ceases transmitting on a designated resource, the collision identifying node may communicate with the other colliding access point. The collision identifying node may thereby inform an access point of the existence and identity of another colliding access point. The access points may then communicate with one another (e.g., via a backhaul) to resolve the collision.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a wireless communication system adapted to identify and resolve collisions;

FIGS. 2A and 2B are a flowchart of several sample aspects of operations that may be performed to identify and resolve a collision;

FIG. 3 is a flowchart of several sample aspects of operations that may be performed to identify a collision when access points transmit via different resources;

FIG. 4 is a simplified block diagram of several sample aspects of components of wireless nodes that may be employed in conjunction with identifying a collision based on transmissions via different resources;

FIG. 5 is a flowchart of several sample aspects of operations that may be performed to identify a collision when access points transmit using different channelization;

FIG. 6 is a simplified block diagram of several sample aspects of components of wireless nodes that may be employed in conjunction with identifying a collision based on transmissions using different channelization;

FIG. 7 is a simplified diagram illustrating sample coverage areas for wireless communication;

FIG. 8 is a simplified diagram of a sample wireless communication system;

FIG. 9 is a simplified diagram of a sample wireless communication system including femto nodes;

FIG. 10 is a simplified block diagram of several sample aspects of communication components; and

FIGS. 11 and 12 are simplified block diagrams of several sample aspects of apparatuses configured to provide collision mitigation as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

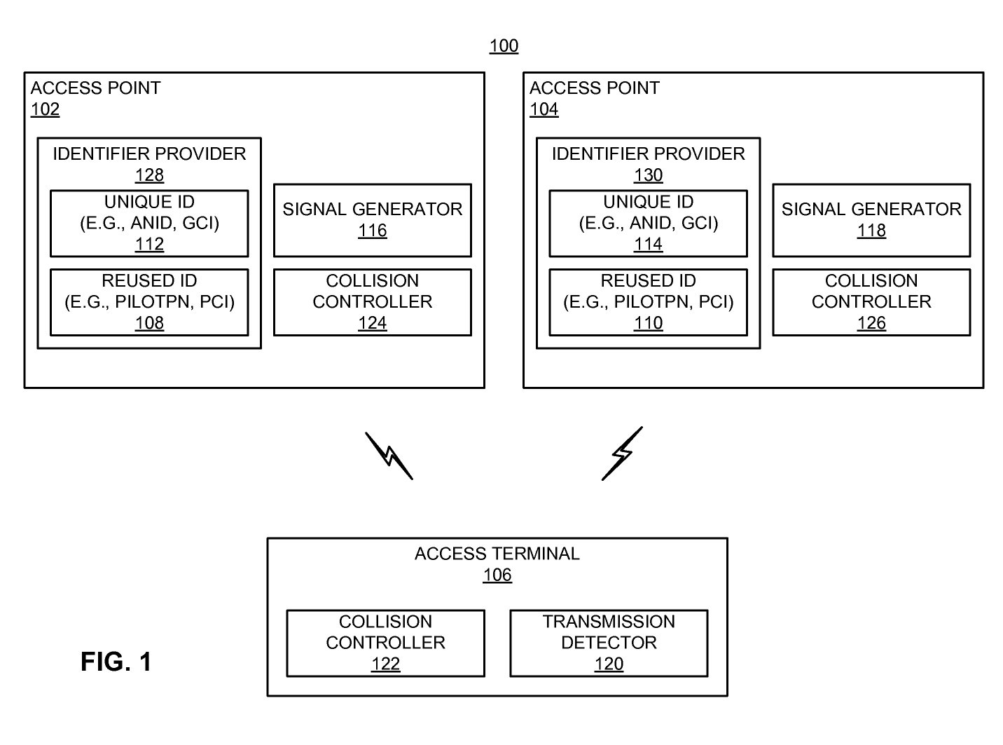

FIG. 1 illustrates several nodes in a sample communication system 100 (e.g., a portion of a communication network). For illustration purposes, various aspects of the disclosure will be described in the context of one or more access terminals and access points that communicate with one another. It should be appreciated, however, that the teachings herein may be applicable to other types of apparatuses or other similar apparatuses that are referenced using other terminology. For example, in various implementations access points may be referred to or implemented as base stations, access terminals may be referred to or implemented as user equipment, and so on.

Access points 102 and 104 in the system 100 provide one or more services (e.g., network connectivity) for one or more access terminals (e.g., access terminal 106) that may reside within or that may roam throughout an associated geographical area. In addition, each of the access points 102 and 104 may communicate with one or more network nodes (not shown) to facilitate wide area network connectivity. Such network nodes may take various forms such as, for example, one or more radio and/or core network entities (e.g., mobility management entities, session reference network controllers, or some other suitable network entity or entities).

FIG. 1 and the discussion that follows describe various schemes where access points in a network generate signals (e.g., in a pseudorandom manner or some other manner) to enable detection of a collision between the access points. For example, a collision may occur when the access points 102 and 104 use the same identifier as the basis (e.g., seed) for channelization. This situation may occur in cases where the access points 102 and 104 use relatively short access point identifiers for this purpose. In such cases, the short identifiers may be reused within the system since the number of access points may exceed the number of available short identifiers. In some implementations these reused identifiers may take the form of PCIs, PilotPNs, or some other type of identifiers assigned to the access points. In the example of FIG. 1, reused identifies 108 and 110 are illustrated as being assigned to the access points 102 and 104, respectively.

In accordance with conventional practice, longer identifiers also may be assigned to the access points 102 and 104. For example, longer identifiers may be used to uniquely identify each access point in a network (e.g., an operator's network, a global network, and so on). In some implementations these unique identifiers may take the form of GCIs, ANIDs, SectorIDs, or some other type of identifiers assigned to the access points. In the example of FIG. 1, unique identifies 112 and 114 are illustrated as being assigned to the access points 102 and 104, respectively.

Each access point includes a signal generator 116 or 118 (e.g., pseudorandom signal generators) for generating signals that may be detected by another node to determine whether the access points 102 and 104 are using the same reused identifier. For illustration purposes, the following discussion describes an example where the access terminal 106 (e.g., by operation of a transmission detector 120) detects a collision based on the signals transmitted by the access points 102 and 104. It should be appreciated, however, that other entities (e.g., other access points) in the system 100 may be configured as taught herein to detect such a collision. In some aspects, the generation of the signals is based on a unique address assigned to the corresponding access point. In this way, the access points 102 and 104 may be guaranteed to generate different signals at some point in time, even if the access points 102 and 104 are using the same reused identifier as the basis for their respective channelization. In some implementations, the signals are generated in a random or pseudorandom manner (e.g., based on a unique address assigned to the corresponding access point) to ensure that the access points 102 and 104 generate different random signals at some point in time.

A collision controller 122 of the access terminal 106 may identify a collision involving the access points 102 and 104 based on the signals detected by the transmission detector 120. In this case, the collision controller 122 may communicate with collision controllers 124 and 126 of the access points 102 and 104, respectively, to resolve the collision.

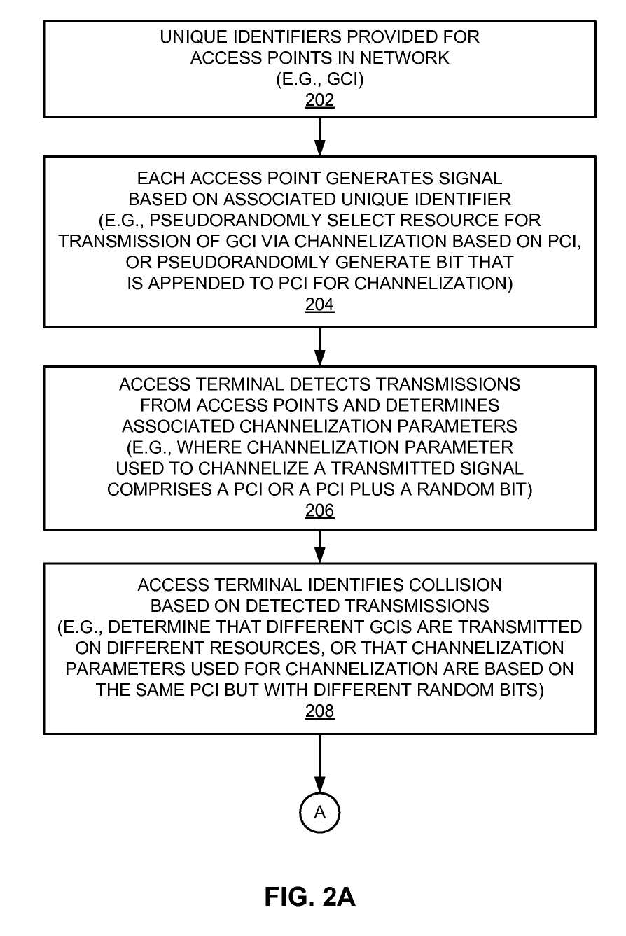

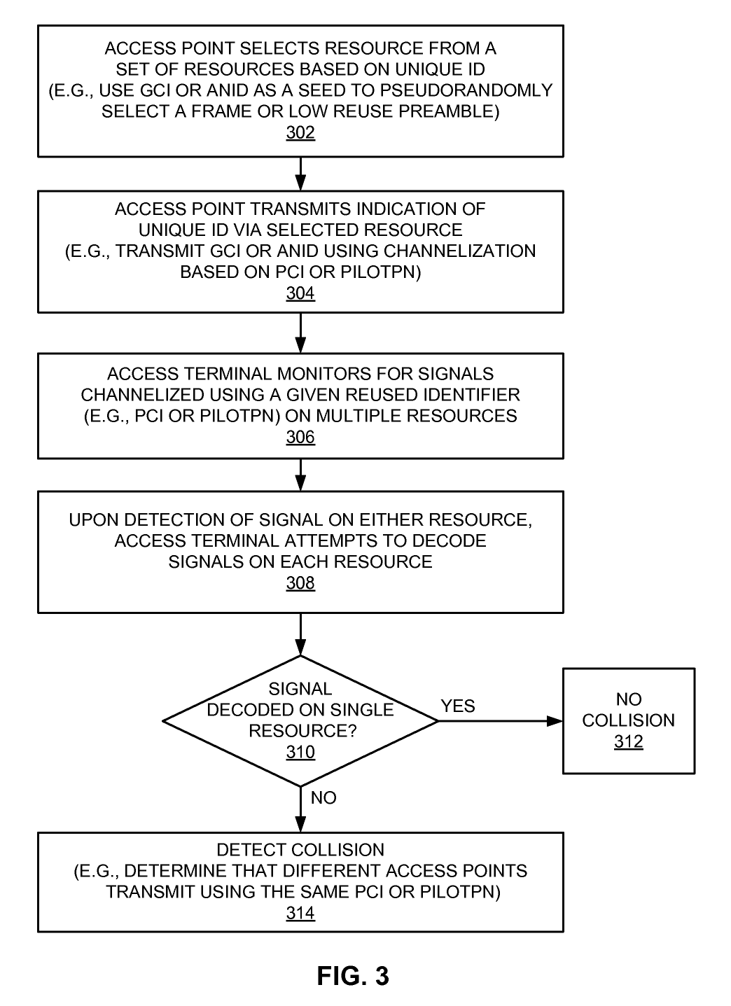

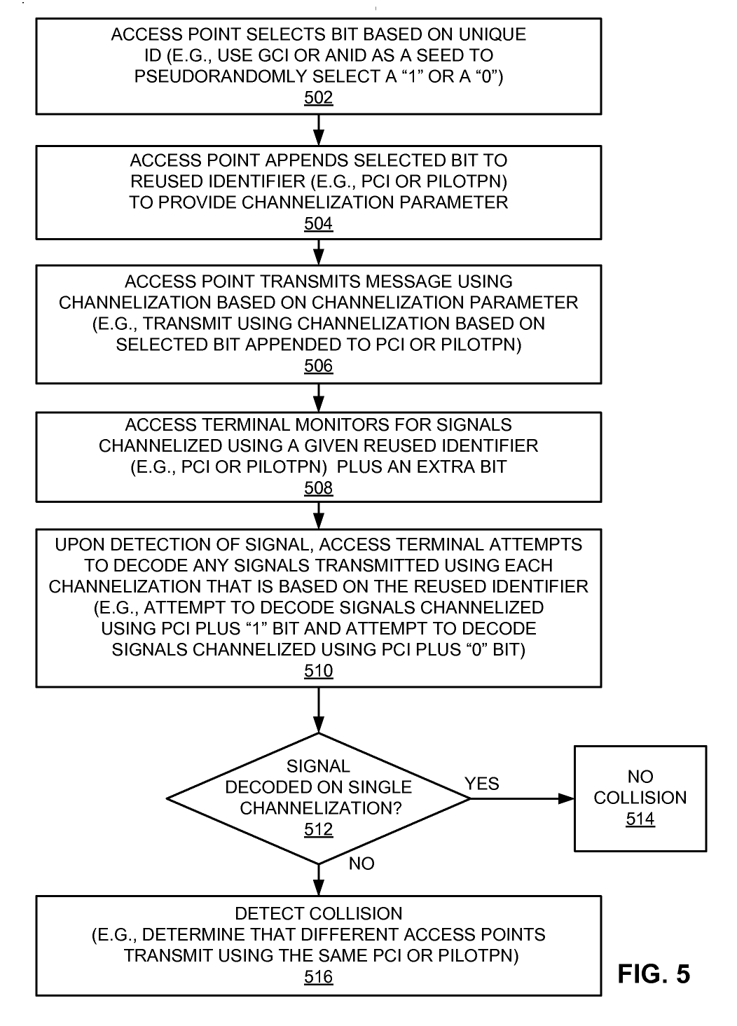

Sample collision mitigation operations will be described in more detail in conjunction with the flowchart of FIGS. 2A and 2B. For convenience, the operations of FIGS. 2A and 2B (or any other operations discussed or taught herein) may be described as being performed by specific components (e.g., components of the system 100 of FIG. 1, the system 400 of FIG. 4, or the system 600 of FIG. 6). It should be appreciated, however, that these operations may be performed by other types of components and may be performed using a different number of components. It also should be appreciated that one or more of the operations described herein may not be employed in a given implementation.

At some point in time a unique identifier is assigned to each access point (e.g., Home eNodeBs) in a wireless network. As mentioned above, such an identifier may comprise a GCI, an ANID, a SectorID, or some other identifier. For convenience, these unique identifiers will be referred to as GCIs in the discussion of FIGS. 2A and 2B that follows. A GCI may be assigned to an access point in various ways. For example, in some cases an operations, administration and management (“OA&M”) network entity or some other suitable entity or entities may assign the GCIs for the access points in a network.

In addition, at some point in time a reused identifier is assigned to each access point. As mentioned above, such an identifier may comprise a PCI, a PilotPN, or some other identifier. For convenience, these reused identifiers will be referred to as PCIs in the discussion of FIGS. 2A and 2B that follows. A PCI may be assigned to an access point in various ways. For example, in some cases a PCI may be assigned to an access point (e.g., autonomously or by a network node) when the access point is deployed. In some cases an access point may be assigned a default PCI (e.g., upon manufacture).

In some cases an access point may conduct neighbor discovery (e.g., by monitoring for transmissions by nearby access points) and attempt to select a PCI that does not conflict with the PCIs used by its neighboring access points. It should be appreciated, however, that in some cases such a scheme may not always avoid collisions. For example, an access point may not be able to hear a neighboring access point, but an access terminal may be able to hear both of these access points. In addition, when a new access point is deployed, collisions may occur with a nearby access point if the access points have not yet discovered one another.

As represented by block 202 of FIG. 2A, when an access point is to generate a signal (e.g., in conjunction with transmitting a pilot), the GCI may be provided as a seed to a signal generator. For example, in FIG. 1 the access points 102 and 104 may include identifier providers 128 and 130, respectively, that are configured to retrieve the GCIs 112 and 114 (e.g., from data memory) and provide the GCIs to the signal generators 116 and 118 (e.g., pseudorandom signal generators), respectively.

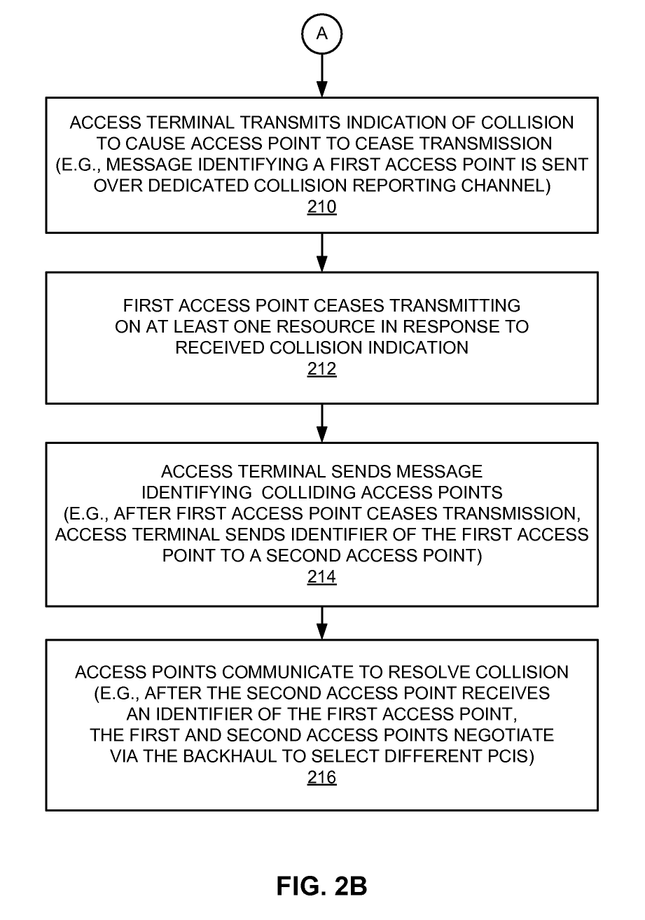

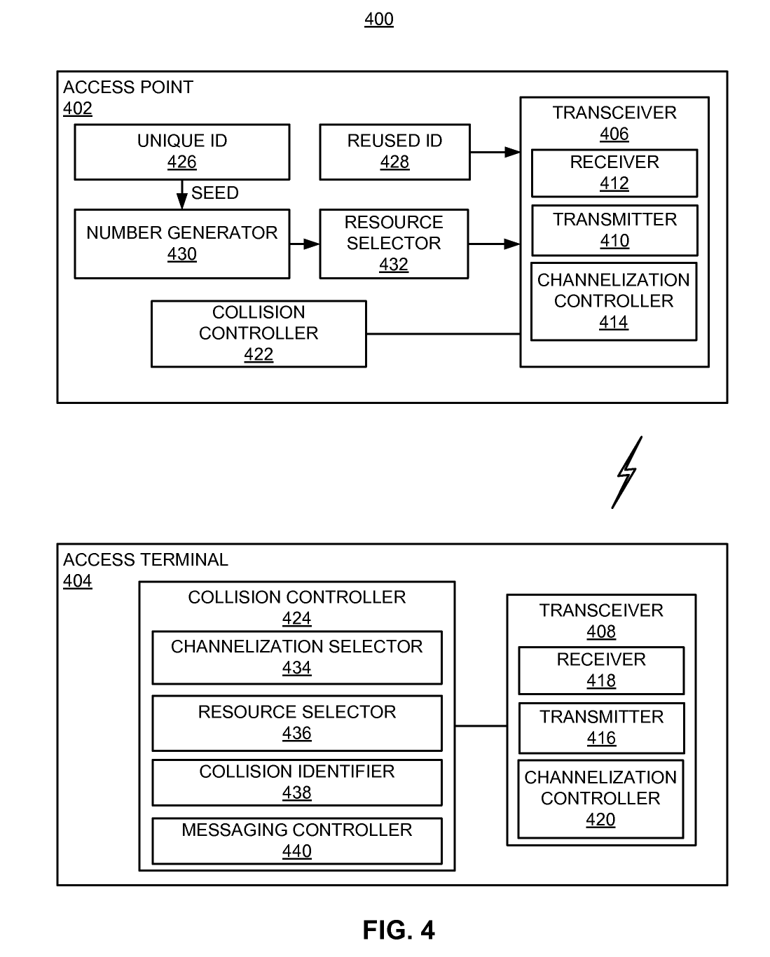

As represented by block 204, each access point may then generate a signal based on the GCI. As will be described in more detail in conjunction with FIGS. 3 and 4, in some implementations each signal generator may select a resource upon which the associated access point transmits an indication of the GCI of the access point. As will be described in more detail in conjunction with FIGS. 5 and 6, in some implementations each signal generator may select one or more bits to be appended to a PCI of that access point to provide a channelization parameter that is used to channelize signals transmitted by the access point.

As represented by block 206, the access terminal 106 (e.g., the transmission detector 120) regularly monitors for transmissions by nearby access points (e.g., access points 102 and 104). For example, the access terminal 106 may monitor for pilot signals and/or other types of signals. As mentioned above, these signals may be channelized based on the PCIs of the access points. Accordingly, the access terminal 106 may determine the PCI used by each of these access points. As described in more detail below, in some implementations an access point may channelize signals based on the PCI assigned to that access point while in other implementations an access point may channelize signals based on the assigned PCI plus one or more defined bits.

As represented by block 208, in the event any nearby access points are using the same PCI, the access terminal 106 (e.g., the collision controller 122) may identify a collision based on the transmissions detected at block 206. As will be described in more detail in conjunction with FIGS. 3 and 4, in some implementations this may involve determining that different GCIs are received via different resources. As will be described in more detail in conjunction with FIGS. 5 and 6, in some implementations this may involve determining that signals channelized based on a common PCI but different appended bits have been received during a given signal time period (e.g., a designated pilot time period).

In the event a PCI collision is identified, the access terminal may attempt to talk to one of the access points to inform the access point of the PCI collision. However, since all of the colliding access points use the same PCI, the access terminal may be not able to receive the downlink channels from the access points due to mutual interference. Similarly, if the access terminal sends a signal to one access point, all of the access points may respond to that signal (e.g., since the signal may be scrambled using the common PCI).

As represented by block 210 of FIG. 2B, the access terminal 106 (e.g., by operation of the collision controller 122) may therefore transmit an indication of the collision in an attempt to cause an access point to cease transmission (e.g., on one or more resources). Here, one or more dedicated channels reserved for collision reporting may be employed. For example, each access point may provide a dedicated channel for reporting collisions. Each of these channels is channelized using the PCI for the corresponding access point. Thus, the access terminal 106 may use one of these channels to send a message to one of the access points to request that access point to cease transmitting.

In some aspects, such message may include an identifier of the access point. For example, the message may include the GCI of the access point, a function (e.g., hash) of the GCI, an indication of the bit (that was appended to the PCI) used by the access point for channelization of the last transmission, or some other suitable identifier.

As represented by block 212, upon receipt of the indication transmitted at block 210, an access point ceases transmitting on at least one resource to enable the access terminal to establish communication using the common PCI. For example, if the access point 102 of FIG. 1 receives a collision indication, the collision controller 124 may temporarily limit transmissions by the access point 102 on certain channels, frames, TDM timeslots, FDM frequencies, etc.

As represented by block 214, once the access point ceases transmitting on the designated resource(s), the access terminal may send a message to another access point to inform that access point of the collision and the identity of the access point(s) in conflict. For example, the collision controller 122 of FIG. 1 may send an identifier (e.g., the GCI) of the access point 102 to the collision controller 126 of the access point 104. Alternatively, the collision controller 122 may establish a tunnel to the access point 102 via the access point 104 and send an identifier (e.g., the GCI) of the access point 104 to the collision controller 124 of the access point 102.

As represented by block 216, upon receipt of the indication transmitted at block 212, an access point may establish communication with an access point in conflict to resolve the collision. For example, the access points 102 and 104 (e.g., by operation of the collision controllers 124 and 126) may negotiate via a backhaul (e.g., as established through one or more networks nodes, not shown in FIG. 1) such that the access points 102 and 104 agree to use different PCIs. In some implementations access points may resolve a collision through the use of access terminal reports, or some other suitable communication mechanism.

Referring now to FIGS. 3 and 4, additional details relating to a scheme where access points transmit signals via different resources will now be described. FIG. 3 describes several operations that may be performed in such a scheme. For purposes of illustration, an example will be described where a collision results from two access points using the same PilotPN.

FIG. 4 describes several components that may be employed in nodes such as an access point 402 and an access terminal 404 to provide such functionality. The described components also may be incorporated into other nodes in a communication system. For example, other nodes in a system may include components similar to those described for the access point 402 and the access terminal 404 to provide similar functionality. A given node may contain one or more of the described components. For example, a node may contain multiple transceiver components that enable the node to operate on multiple frequencies and/or communicate via different technology.

As shown in FIG. 4, the access point 402 and the access terminal 404 may include respective transceivers 406 and 408 for communicating with one another and with other nodes. The transceiver 406 includes a transmitter 410 for sending signals (e.g., messages), a receiver 412 for receiving signals, and a channelization controller 414 for controlling channelization used for transmitting and receiving signals. Similarly, the transceiver 408 includes a transmitter 416 for sending signals, a receiver 418 for receiving signals, and a channelization controller 420 for controlling channelization used for transmitting and receiving signals.

The access point 402 and the access terminal 404 include other components that may be used in conjunction with collision mitigation operations as taught herein. For example, the access point 402 and the access terminal 404 include respective collision controllers 422 and 424 for managing collision-related operations and communications with other nodes (e.g., sending and receiving messages/indications) and for providing other related functionality as taught herein.

In some aspects the components of FIG. 4 may correspond to the components described above in conjunction with FIG. 1. For example, the collision controllers 422 and 424 may correspond to the collision controllers of FIG. 1. The unique ID 426 and the reused ID 428 may correspond to the unique ID 112 and the reused ID 108, respectively. Also, the signal generator 116 of FIG. 1 may correspond to the number generator 430 (e.g., a pseudorandom number generator), the resource selector 432, and a portion of the transceiver 406. The transmission detector 120 may correspond to a portion of the transceiver 408. Other aspects of the access point 402 and the access terminal 404 are described below.

Referring now to the operations of FIG. 3, as represented by block 302, when the access point 402 is to generate a signal (e.g., in conjunction with transmitting a pilot on a pilot channel), the access point 402 uses the unique ID 426 to select a resource from a set of resources for transmitting an identifier of the access point 402. For example, the unique ID 426 may be used as a seed for the number generator 430 such that a number output by the number generator 430 is used by the resource selector 432 to select a resource. As mentioned above, in some implementations an access point may generate a pseudorandom signal. In such a case, the access point 402 may pseudorandomly select a resource for transmitting an identifier of the access point 402. For example, the unique ID 426 may be provided to a pseudorandom number generator 430 that provides a pseudorandom number to the resource selector 432.

As a specific example, some implementations may employ a low reuse preamble (“LRP”) that is transmitted over two physical (PHY) frames. Any given access point chooses one subband (e.g., 1.25 MHz bandwidth) in one of the two LRP frames. The low reuse nature of the preamble may ensure that an access terminal can see access points that have very different receive signal strengths. In such a case, each access point may transmit a channel (e.g., an ANID channel) in some pre-determined LRP instances. In this way, each access point may provide a channel that enables an access terminal to detect a collision (e.g., a PilotPN collision). Here, at block 302, the PHY frame in which the channel is transmitted may be chosen randomly, pseudorandomly, or in some other manner based, for example, on a function of the unique identifier (e.g., a hash of the ANID). In this way, at some points in time a given access point selects the first frame and at other points in time that access point selects the second frame. The other access points in the system will perform similar operations. Thus, in the event two access points used the same PilotPN, at least some of the time these access points will select different resources for their ANID channels.

As represented by block 304, the access point 402 then transmits an indication of the unique identifier via the selected resource. Continuing with the above example, the access point 402 may transmit a unique identifier of the access point (e.g., the full SectorID) or enough bits of the identifier to allow for unambiguous resolution of the identifier via the channel on the selected frame. Here, the transmitted signal may be channelized based on the reused ID 428 (e.g., a PilotPN). In some aspect, channelization may relate to one or more of time hopping, scrambling, or error correction (e.g., CRC operations). For example, the channel modulation and scrambling may depend on the PilotPN. In addition, the subcarriers in which the channel is transmitted within that frame may be chosen based on the PilotPN.

As represented by block 306, the access terminal 404 regularly monitors for signals from access points as discussed above. In this case, the access terminal 404 may monitor for signals channelized using a given reused identifier (e.g., PilotPN) on multiple resources (e.g., different frames). In the example of FIG. 4, this may be accomplished by cooperation of a channelization selector 434 that selects the channelization to be searched, a resource selector 436 that identifies the resources to be checked, and the transceiver 408.

As represented by block 308, upon detection of a signal on either resource (e.g., the access terminal 404 detects the PilotPN on either of the LRP frames), the access terminal 404 attempts to decode signals on each resource. Continuing with the above example, the access point 402 may attempt to use a given PilotPN to decode the ANID channel on the first PHY frame and to decode the ANID channel on the second PHY frame.

As represented by block 310, in the event a signal is decoded on only one resource (e.g., the ANID channel is decoded only one PHY frame), the operational flow proceeds to block 312 since no collision is indicated. In this case, the access terminal may process the received signal in a normal manner (e.g., to identify a given access point).

In contrast, in the event the signal is decoded on both resources (e.g., the first and second PHY frames), the operational flow proceeds to block 314 whereby the access point (e.g., the collision identifier 438) detects a collision. For example, the collision identifier 428 may determine that different unique identifiers (e.g., ANIDs) were received in the different PHY frames, even though the channelization for both received signals is based on the same PilotPN. In this case, the messaging controller 440 may cooperate with the transceiver 408 to inform the access point of the collision (e.g., using a dedicated collision reporting uplink channel as described above in conjunction with FIG. 2).

Referring now to FIGS. 5 and 6, additional details relating to a scheme where each access point selects (e.g., pseudorandomly selects) a bit and appends that bit to a reused identifier (e.g., a PCI) of that access point to provide a channelization parameter that is used to channelize signals transmitted by the access point will now be described. FIG. 5 describes several operations that may be performed in such a scheme. For purposes of illustration, an example will be described where a collision results from two access points using the same PCI.

FIG. 6 describes several components that may be employed in nodes such as an access point 602 and an access terminal 604 to provide the above functionality. As above, the described components also may be incorporated into other nodes in a communication system and a given node may contain one or more of the described components.

The access point 602 and the access terminal 604 include respective transceivers 606 and 608 for communicating with one another and with other nodes. The transceiver 606 includes a transmitter 610, a receiver 612, and a channelization controller 614, while the transceiver 608 includes a transmitter 616, a receiver 618, and a channelization controller 620.

As above, the access point 602 and the access terminal 604 include other components that may be used in conjunction with collision mitigation operations as taught herein. For example, the access point 602 and the access terminal 604 include respective collision controllers 622 and 624 for managing collision-related operations and communications with other nodes (e.g., sending and receiving messages/indications) and for providing other related functionality as taught herein.

In some aspects the components of FIG. 6 also may correspond to the components described above in conjunction with FIG. 1. For example, the collision controllers 622 and 624 may correspond to the collision controllers of FIG. 1. The unique ID 626 and the reused ID 628 may correspond to the unique ID 112 and the reused ID 108, respectively. The signal generator 116 may correspond to the number generator 630 (e.g., a pseudorandom number generator), the channelization parameter selector 632, and a portion of the transceiver 606. The transmission detector 120 may correspond to a portion of the transceiver 608. Other aspects of the access point 602 and the access terminal 604 are described below.

Referring now to the operations of FIG. 5, as represented by block 502, when the access point 602 is to generate a signal (e.g., in conjunction with transmitting a pilot on a pilot channel), the access point 602 uses the unique ID 626 to select a bit to be appended to the PCI to provide a channelization parameter. For example, the unique ID 626 may be used as a seed for the number generator 630 such that a bit value output by the number generator 630 is appended by the channelization parameter selector 632 to the reused ID 628 (block 504). As mentioned above, in some implementations an access point may generate a pseudorandom signal. In such a case, the access point 602 may pseudorandomly select a bit to be appended to the PCI to provide a channelization parameter. For example, the unique ID 626 may be provided to a pseudorandom number generator 630 that provides a pseudorandom number to the channelization parameter selector 632.

In a similar manner as discussed above, the appended bit may be chosen randomly, pseudorandomly, or in some other manner based on, for example, a hash of the unique identifier (e.g., the GCI). In this way, at some points in time a given access point selects one value of the bit (e.g., “0”) and at other points in time that access point selects another value of the bit (e.g., “1”). The other access points in the system will perform similar operations. Thus, in the event two access points used the same PCI, at least some of the time these access points will select different bits for their channelization parameters.

As represented by block 506, the access point 602 then transmits a signal that is channelized using the defined channelization parameter. For example, the pilot signal transmitted by the access point may be channelized in this manner.

As represented by block 508, the access terminal 604 regularly monitors for signals from access points as discussed above. In this case, the access terminal 604 may monitor for signals channelized based on a given PCI with different values of the appended bit. In the example of FIG. 6, this may be accomplished by cooperation of a channelization selector 634 that selects the channelization to be searched and the transceiver 608.

As represented by block 510, upon detection of a signal associated with either channelization for a PCI, the access terminal 604 attempts to decode signals associated with each channelization. For example, the access point 602 may use a given PCI plus a “0” bit in an attempt to decode one received signal and use that same PCI plus a “1” bit in an attempt to decode another received signal.

As represented by block 512, in the event a signal is decoded only for one channelization for a given PCI, the operational flow proceeds to block 514 since no collision is indicated. In this case, the access terminal may process the received signal in a normal manner (e.g., to identify a given access point).

In contrast, in the event the signal is decoded on both channelizations for a given PCI (e.g., for an appended “0” and an appended “1”), the operational flow proceeds to block 516 whereby the access point (e.g., the collision identifier 636) detects a collision. In this case, the messaging controller 638 may cooperate with the transceiver 608 to inform the access point of the collision (e.g., using a dedicated collision reporting uplink channel as described above in conjunction with FIG. 2).

It should be appreciated that the teachings herein may be implemented in various ways. For example, some implementations may provide collision mitigation by changing resources and channelization parameters. Also, random, pseudorandom, or other types of changes may be employed in various implementations. In some implementations, collision mitigation may be provided through the use of changes in waveforms (i.e., signals) based on a unique identifier (e.g., GCI) in ways that involve techniques other than changing the bits in a channelization parameter.

In some aspects, collision mitigation schemes as taught herein may be used in a mixed deployment that includes macro coverage (e.g., a large area cellular network such as a 3G network, typically referred to as a macro cell network or a Wide Area Network—WAN) and smaller coverage (e.g., a residence-based or building-based network environment, typically referred to as a Local Area Network—LAN). Here, as an access terminal (“AT”) moves through such a network, the access terminal may be served in certain locations by access points that provide macro coverage while the access terminal may be served at other locations by access points that provide smaller area coverage. In some aspects, the smaller area coverage nodes may be used to provide incremental capacity growth, in-building coverage, and different services, all leading to a more robust user experience.

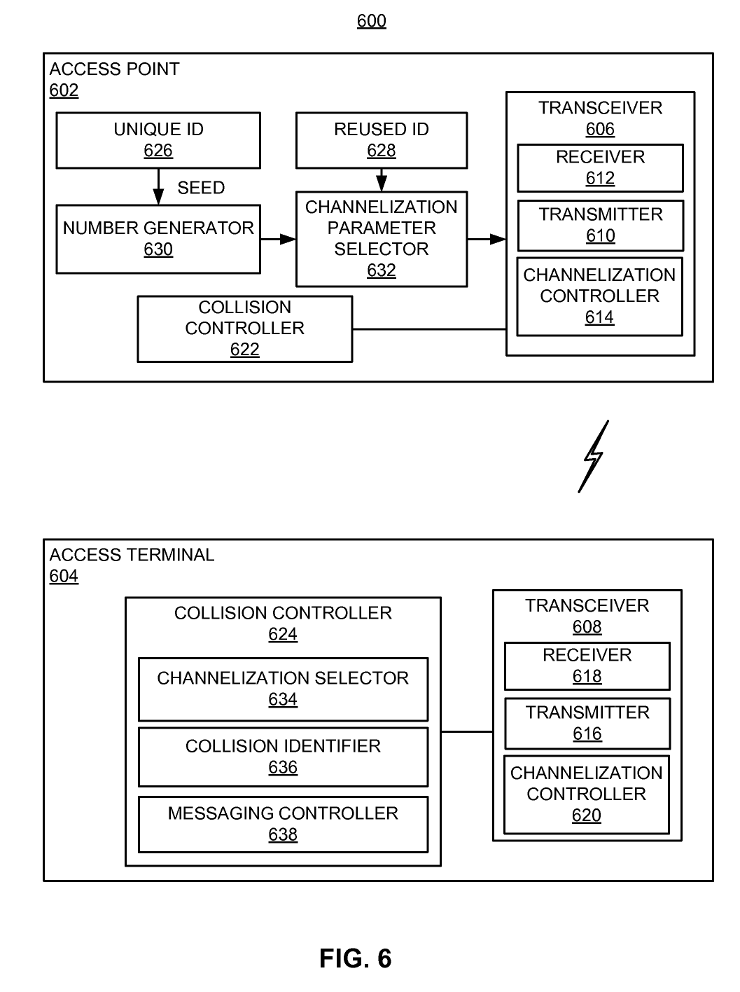

A node that provides coverage over a relatively large area may be referred to as a macro node while a node that provides coverage over a relatively small area (e.g., a residence) may be referred to as a femto node. It should be appreciated that the teachings herein may be applicable to nodes associated with other types of coverage areas. For example, a pico node may provide coverage over an area that is smaller than a macro area and larger than a femto area (e.g., coverage within a commercial building). In various applications, other terminology may be used to reference a macro node, a femto node, or other access point-type nodes. For example, a macro node may be configured or referred to as an access node, base station, access point, eNodeB, macro cell, and so on. Also, a femto node may be configured or referred to as a Home NodeB, Home eNodeB, access point base station, femto cell, and so on. In some implementations, a node may be associated with (e.g., divided into) one or more cells or sectors. A cell or sector associated with a macro node, a femto node, or a pico node may be referred to as a macro cell, a femto cell, or a pico cell, respectively. A simplified example of how femto nodes may be deployed in a network is provided in FIG. 7.

FIG. 7 illustrates an example of a coverage map 700 where several tracking areas 702 (or routing areas or location areas) are defined, each of which includes several macro coverage areas 704. Here, areas of coverage associated with tracking areas 702A, 702B, and 702C are delineated by the wide lines and the macro coverage areas 704 are represented by the hexagons. The tracking areas 702 also include femto coverage areas 706. In this example, each of the femto coverage areas 706 (e.g., femto coverage area 706C) is depicted within a macro coverage area 704 (e.g., macro coverage area 704B). It should be appreciated, however, that a femto coverage area 706 may lie partially within or outside of a macro coverage area 704. Also, one or more pico coverage areas (not shown) may be defined within one or more tracking areas 702 or macro coverage areas 704. It should be appreciated that there could be multiple femto coverage areas within a macro coverage area, either within it or straddling across boundaries with adjacent macro cells.

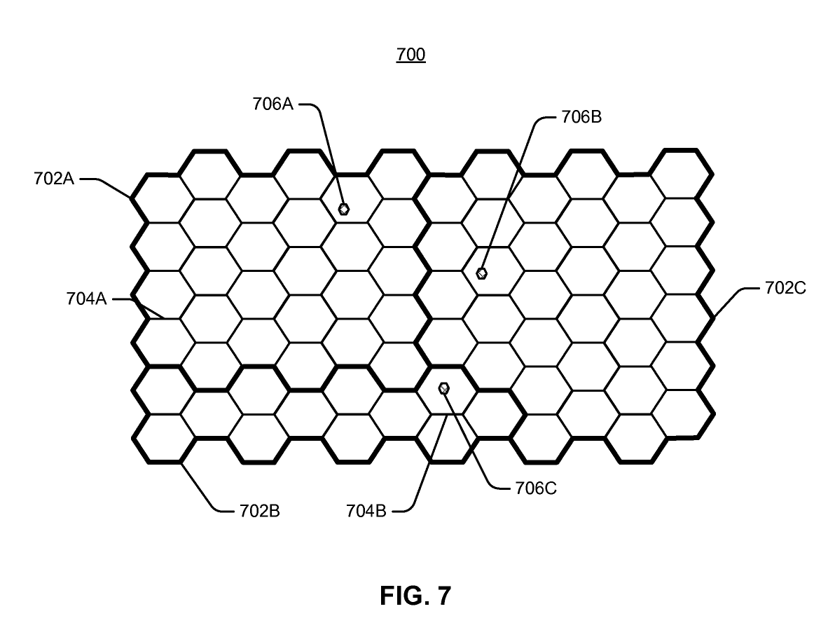

FIG. 8 illustrates several aspects of a wireless communication system 800 comprising multiple cells 802, such as, for example, macro cells 802A-802G, with each cell being serviced by a corresponding access point 804 (e.g., access points 804A-804G). Thus, the macro cells 802 may correspond to the macro coverage areas 704 of FIG. 7. As shown in FIG. 8, access terminals 806 (e.g., access terminals 806A-806L) may be dispersed at various locations throughout the system over time. Each access terminal 806 may communicate with one or more access points 804 on a forward link (“FL”) and/or a reverse link (“RL) at a given moment, depending upon whether the access terminal 806 is active and whether it is in soft handoff, for example. The wireless communication system 800 may provide service over a large geographic region. For example, macro cells 802A-802G may cover a few blocks in a neighborhood or several square miles in rural environment.

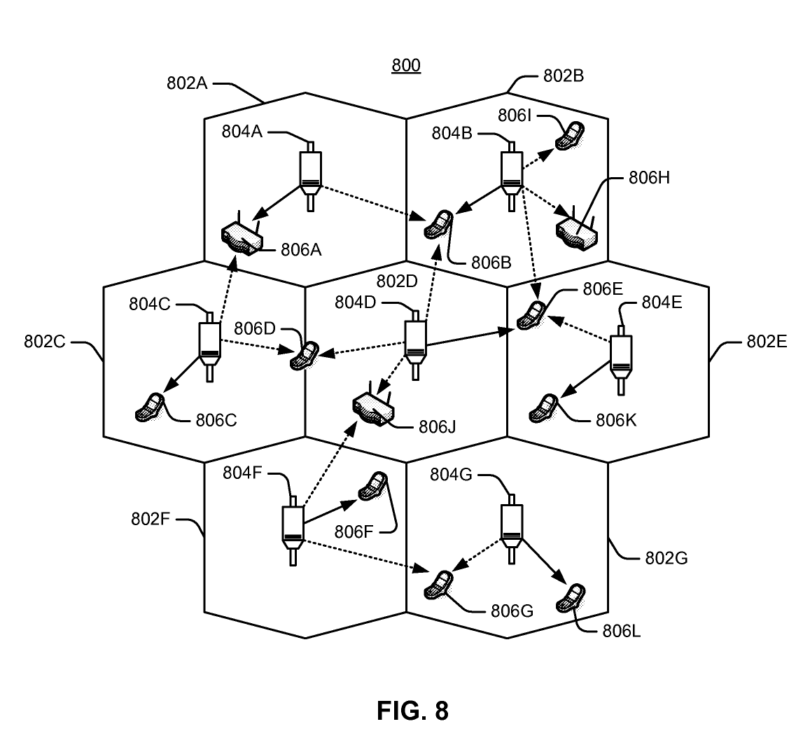

FIG. 9 is an example of a system 900 that illustrates how one or more femto nodes may be deployed within a network environment (e.g., the system 800). The system 900 includes multiple femto nodes 910 (e.g., femto nodes 910A and 910B) installed in a relatively small area coverage network environment (e.g., in one or more user residences 930). Each femto node 910 may be coupled to a wide area network 940 (e.g., the Internet) and a mobile operator core network 950 via a DSL router, a cable modem, a wireless link, or other connectivity means (not shown).

The owner of a femto node 910 may subscribe to mobile service, such as, for example, 3G mobile service, offered through the mobile operator core network 950. In addition, an access terminal 920 may be capable of operating both in macro environments and in smaller area coverage (e.g., residential) network environments. In other words, depending on the current location of the access terminal 920, the access terminal 920 may be served by a macro cell access point 960 associated with the mobile operator core network 950 or by any one of a set of femto nodes 910 (e.g., the femto nodes 910A and 910B that reside within a corresponding user residence 930). For example, when a subscriber is outside his home, he may be served by a standard macro access point (e.g., access point 960) and when the subscriber is near or inside his home, he may be served by a femto node (e.g., node 910A). Here, a femto node 910 may be backward compatible with legacy access terminals 920.

As mentioned above, a node (e.g., a femto node) may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes 910 that reside within the corresponding user residence 930). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access points (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association (e.g., the femto node allows access to any access terminal). A restricted femto node may refer to a femto node that is restricted in some manner (e.g., restricted for association and/or registration). A home femto node may refer to a femto node on which the access terminal is authorized to access and operate on (e.g., permanent access is provided for a defined set of one or more access terminals). A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that is authorized to access the restricted femto node (e.g., the access terminal has permanent access to the femto node). A guest access terminal may refer to an access terminal with temporary access to the restricted femto node (e.g., limited based on deadline, time of use, bytes, connection count, or some other criterion or criteria). An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node may provide the same or similar functionality for a larger coverage area. For example, a pico node may be restricted, a home pico node may be defined for a given access terminal, and so on.

A wireless multiple-access communication system may simultaneously support communication for multiple wireless access terminals. Each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T},N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

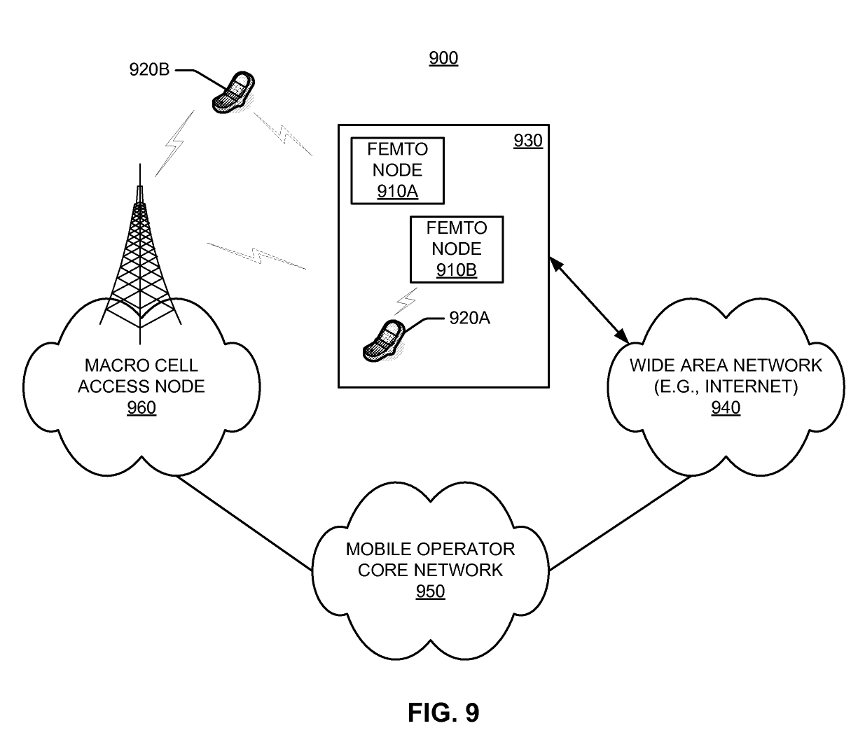

The teachings herein may be incorporated into a node (e.g., a device) employing various components for communicating with at least one other node. FIG. 10 depicts several sample components that may be employed to facilitate communication between nodes. Specifically, FIG. 10 illustrates a wireless device 1010 (e.g., an access point) and a wireless device 1050 (e.g., an access terminal) of a MIMO system 1000. At the device 1010, traffic data for a number of data streams is provided from a data source 1012 to a transmit (“TX”) data processor 1014.

In some aspects, each data stream is transmitted over a respective transmit antenna. The TX data processor 1014 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1030. A data memory 1032 may store program code, data, and other information used by the processor 1030 or other components of the device 1010.

The modulation symbols for all data streams are then provided to a TX MIMO processor 1020, which may further process the modulation symbols (e.g., for OFDM). The TX MIMO processor 1020 then provides N_{T} modulation symbol streams to N_{T} transceivers (“XCVR”) 1022A through 1022T. In some aspects, the TX MIMO processor 1020 applies beam-forming weights to the symbols of the data streams and to the antenna from which the symbol is being transmitted.

Each transceiver 1022 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1022A through 1022T are then transmitted from N_{T} antennas 1024A through 1024T, respectively.

At the device 1050, the transmitted modulated signals are received by N_{R} antennas 1052A through 1052R and the received signal from each antenna 1052 is provided to a respective transceiver (“XCVR”) 1054A through 1054R. Each transceiver 1054 conditions (e.g., filters, amplifies, and downconverts) a respective received signal, digitizes the conditioned signal to provide samples, and further processes the samples to provide a corresponding “received” symbol stream.

A receive (“RX”) data processor 1060 then receives and processes the N_{R} received symbol streams from N_{R} transceivers 1054 based on a particular receiver processing technique to provide N_{T} “detected” symbol streams. The RX data processor 1060 then demodulates, deinterleaves, and decodes each detected symbol stream to recover the traffic data for the data stream. The processing by the RX data processor 1060 is complementary to that performed by the TX MIMO processor 1020 and the TX data processor 1014 at the device 1010.

A processor 1070 periodically determines which pre-coding matrix to use (discussed below). The processor 1070 formulates a reverse link message comprising a matrix index portion and a rank value portion. A data memory 1072 may store program code, data, and other information used by the processor 1070 or other components of the device 1050.

The reverse link message may comprise various types of information regarding the communication link and/or the received data stream. The reverse link message is then processed by a TX data processor 1038, which also receives traffic data for a number of data streams from a data source 1036, modulated by a modulator 1080, conditioned by the transceivers 1054A through 1054R, and transmitted back to the device 1010.

At the device 1010, the modulated signals from the device 1050 are received by the antennas 1024, conditioned by the transceivers 1022, demodulated by a demodulator (“DEMOD”) 1040, and processed by a RX data processor 1042 to extract the reverse link message transmitted by the device 1050. The processor 1030 then determines which pre-coding matrix to use for determining the beam-forming weights then processes the extracted message.

FIG. 10 also illustrates that the communication components may include one or more components that perform collision control operations as taught herein. For example, a collision control component 1090 may cooperate with the processor 1030 and/or other components of the device 1010 to send/receive signals to/from another device (e.g., device 1050) as taught herein. Similarly, a collision control component 1092 may cooperate with the processor 1070 and/or other components of the device 1050 to send/receive signals to/from another device (e.g., device 1010). It should be appreciated that for each device 1010 and 1050 the functionality of two or more of the described components may be provided by a single component. For example, a single processing component may provide the functionality of the collision control component 1090 and the processor 1030 and a single processing component may provide the functionality of the collision control component 1092 and the processor 1070.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (“CDMA”) systems, Multiple-Carrier CDMA (“MCCDMA”), Wideband CDMA (“W-CDMA”), High-Speed Packet Access (“HSPA,” “HSPA+”) systems, Time Division Multiple Access (“TDMA”) systems, Frequency Division Multiple Access (“FDMA”) systems, Single-Carrier FDMA (“SC-FDMA”) systems, Orthogonal Frequency Division Multiple Access (“OFDMA”) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (“UTRA)”, cdma2000, or some other technology. UTRA includes W-CDMA and Low Chip Rate (“LCR”). The cdma2000 technology covers IS-2000, IS-95 and IS-856 standards. A TDMA network may implement a radio technology such as Global System for Mobile Communications (“GSM”). An OFDMA network may implement a radio technology such as Evolved UTRA (“E-UTRA”), IEEE 802.11, IEEE 802.16, IEEE 802.20, Flash-OFDM®, etc. UTRA, E-UTRA, and GSM are part of Universal Mobile Telecommunication System (“UMTS”). The teachings herein may be implemented in a 3GPP Long Term Evolution (“LTE”) system, an Ultra-Mobile Broadband (“UMB”) system, and other types of systems. LTE is a release of UMTS that uses E-UTRA. Although certain aspects of the disclosure may be described using 3GPP terminology, it is to be understood that the teachings herein may be applied to 3GPP (Rel99, Rel5, Rel6, Rel7) technology, as well as 3GPP2 (1xRTT, 1xEV-DO RelO, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (“RNC”), a base station (“BS”), a radio base station (“RBS”), a base station controller (“BSC”), a base transceiver station (“BTS”), a transceiver function (“TF”), a radio transceiver, a radio router, a basic service set (“BSS”), an extended service set (“ESS”), or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

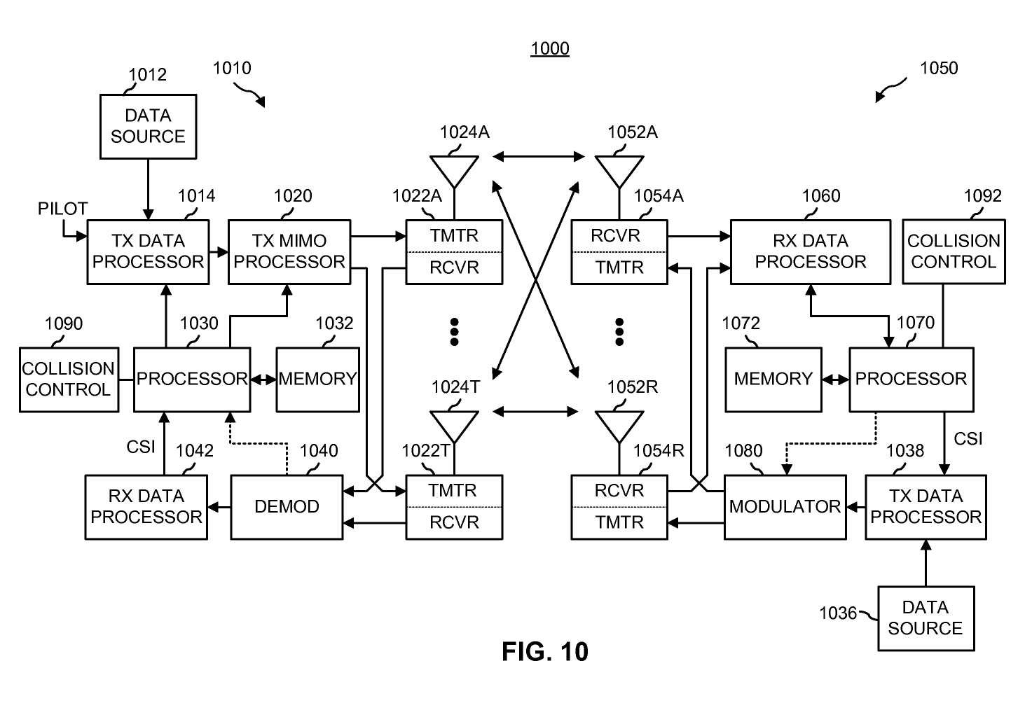

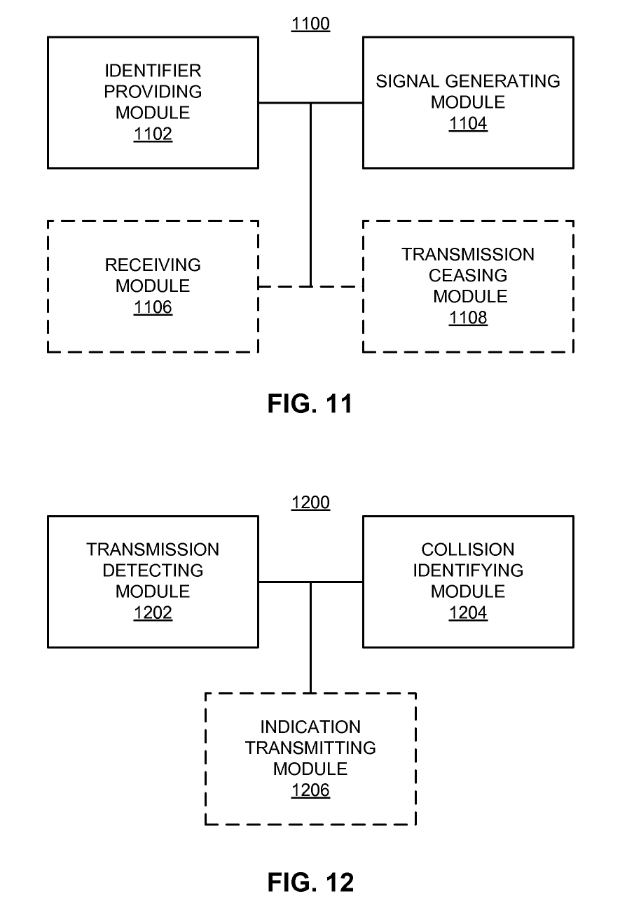

The components described herein may be implemented in a variety of ways. Referring to FIGS. 11 and 12, apparatuses 1100 and 1200 are represented as a series of interrelated functional blocks (e.g., corresponding to various modules). In some aspects the functionality of these blocks may be implemented as one or more electrical components. In some aspects the functionality of these blocks may be implemented as a processing system including one or more processor components. In some aspects the functionality of these blocks may be implemented using, for example, at least a portion of one or more integrated circuits (e.g., an ASIC). As discussed herein, an integrated circuit may include a processor, software, other related components, or some combination thereof. The functionality of these blocks also may be implemented in some other manner as taught herein. In some aspects one or more of the dashed blocks in FIGS. 11 and 12 are optional.

The apparatuses 1100 and 1200 may include one or more modules that may perform one or more of the functions described above with regard to various figures. For example, an identifier providing module 1102 may correspond to, for example, an identifier provider as discussed herein. A signal generating module 1104 may correspond to, for example, a signal generator as discussed herein. A receiving module 1106 may correspond to, for example, a receiver as discussed herein. A transmission ceasing module 1108 may correspond to, for example, a collision controller as discussed herein. A transmission detecting module 1202 may correspond to, for example, a receiver as discussed herein. A collision identifying module 1204 may correspond to, for example, a collision identifier as discussed herein. An indication transmitting module 1206 may correspond to, for example, a transmitter as discussed herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Thus, it should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of wireless communication, comprising:
providing a first identifier that uniquely identifies an access point within a network; and
generating a signal based on the first identifier.

2. The method of claim 1, wherein the signal is generated pseudorandomly based on the first identifier.

3. The method of claim 1, wherein the first identifier comprises a global cell identifier, an access node identifier, or a sector identifier.

4. The method of claim 1, wherein the generation of the signal comprises:
defining at least one bit based on the first identifier;
providing a channelization parameter by appending the at least one bit to a second identifier of the access point, wherein the second identifier is shorter than the first identifier; and
transmitting the signal using channelization based on the channelization parameter.

5. The method of claim 4, wherein the at least one bit is defined pseudorandomly based on the first identifier.

6. The method of claim 4, wherein:
the second identifier comprises a physical cell identifier or pilot pseudorandom number identifier; and
the channelization comprises at least one of the group consisting of: time hopping, scrambling, and error correction.

7. The method of claim 1, wherein the generation of the signal comprises:
selecting a resource from a set of resources; and
transmitting an indication of the first identifier via the selected resource.

8. The method of claim 7, wherein the resource is selected pseudorandomly based on the first identifier.

9. The method of claim 7, wherein the set of resources comprises at least one of the group consisting of: a set of frames, a set of low reuse preambles, a set of time division multiplexed resources, and a set of frequency division multiplexed resources.

10. The method of claim 7, wherein:
the transmission of the indication uses channelization based on a second identifier of the access point; and
the second identifier is shorter than the first identifier.

11. The method of claim 10, wherein:
the second identifier comprises a physical cell identifier or pilot pseudorandom number identifier; and
the channelization comprises at least one of the group consisting of: time hopping, scrambling, and error correction.

12. The method of claim 1, wherein the generation of the signal comprises transmitting the signal using channelization based on a second identifier of the access point, the method further comprising:
receiving an indication of a collision associated with use of the second identifier.

13. The method of claim 12, further comprising:
receiving an identifier of another access point that uses the second identifier; and
communicating with the another access point to resolve the collision.

14. The method of claim 12, wherein the indication of the collision is received via a channel dedicated for collision reporting, the method further comprising:
ceasing transmission on at least one resource in response to the receipt of the indication of the collision.

15. An apparatus for wireless communication, comprising:
an identifier provider configured to provide a first identifier that uniquely identifies an access point within a network; and
a signal generator configured to generate a signal based on the first identifier.

16. The apparatus of claim 15, wherein the signal is generated pseudorandomly based on the first identifier.

17. The apparatus of claim 15, wherein the first identifier comprises a global cell identifier, an access node identifier, or a sector identifier.

18. The apparatus of claim 15, wherein the generation of the signal comprises:
defining at least one bit based on the first identifier;
providing a channelization parameter by appending the at least one bit to a second identifier of the access point, wherein the second identifier is shorter than the first identifier; and
transmitting the signal using channelization based on the channelization parameter.

19. The apparatus of claim 18, wherein the at least one bit is defined pseudorandomly based on the first identifier.

20. The apparatus of claim 18, wherein:
the second identifier comprises a physical cell identifier or pilot pseudorandom number identifier; and
the channelization comprises at least one of the group consisting of: time hopping, scrambling, and error correction.

21. The apparatus of claim 15, wherein the generation of the signal comprises:
selecting a resource from a set of resources; and
transmitting an indication of the first identifier via the selected resource.

22. The apparatus of claim 21, wherein the resource is selected pseudorandomly based on the first identifier.

23. The apparatus of claim 21, wherein:
the transmission of the indication uses channelization based on a second identifier of the access point; and
the second identifier is shorter than the first identifier.

24. The apparatus of claim 15, wherein the generation of the signal comprises transmitting the signal using channelization based on a second identifier of the access point, the apparatus further comprising:
a receiver configured to receive, via a channel dedicated for collision reporting, an indication of a collision associated with use of the second identifier; and
a collision controller configured to cease transmission on at least one resource in response to the receipt of the indication of the collision.

25. An apparatus for wireless communication, comprising:
means for providing a first identifier that uniquely identifies an access point within a network; and
means for generating a signal based on the first identifier.

26. The apparatus of claim 25, wherein the signal is generated pseudorandomly based on the first identifier.

27. The apparatus of claim 25, wherein the first identifier comprises a global cell identifier, an access node identifier, or a sector identifier.

28. The apparatus of claim 25, wherein the generation of the signal comprises:
defining at least one bit based on the first identifier;
providing a channelization parameter by appending the at least one bit to a second identifier of the access point, wherein the second identifier is shorter than the first identifier; and
transmitting the signal using channelization based on the channelization parameter.

29. The apparatus of claim 28, wherein the at least one bit is defined pseudorandomly based on the first identifier.

30. The apparatus of claim 28, wherein:
the second identifier comprises a physical cell identifier or pilot pseudorandom number identifier; and
the channelization comprises at least one of the group consisting of: time hopping, scrambling, and error correction.

31. The apparatus of claim 25, wherein the generation of the signal comprises:
selecting a resource from a set of resources; and
transmitting an indication of the first identifier via the selected resource.

32. The apparatus of claim 31, wherein the resource is selected pseudorandomly based on the first identifier.

33. The apparatus of claim 31, wherein:
the transmission of the indication uses channelization based on a second identifier of the access point; and
the second identifier is shorter than the first identifier.

34. The apparatus of claim 25, wherein the generation of the signal comprises transmitting the signal using channelization based on a second identifier of the access point, the apparatus further comprising:
means for receiving, via a channel dedicated for collision reporting, an indication of a collision associated with use of the second identifier; and
means for ceasing transmission on at least one resource in response to the receipt of the indication of the collision.

35. A computer-program product, comprising:
computer-readable medium comprising codes for causing a computer to:
provide a first identifier that uniquely identifies an access point within a network; and
generate a signal based on the first identifier.

36. The computer-program product of claim 35, wherein the signal is generated pseudorandomly based on the first identifier.

37. The computer-program product of claim 35, wherein the generation of the signal comprises:
defining at least one bit based on the first identifier;
providing a channelization parameter by appending the at least one bit to a second identifier of the access point, wherein the second identifier is shorter than the first identifier; and
transmitting the signal using channelization based on the channelization parameter.

38. The computer-program product of claim 35, wherein the generation of the signal comprises:
selecting a resource from a set of resources; and
transmitting an indication of the first identifier via the selected resource.

39. A method of wireless communication, comprising:
detecting a transmission from a first access point that is channelized based on a reused access point identifier;
detecting a transmission from a second access point that is channelized based on the reused access point identifier; and
identifying a collision based on the detections of the transmissions.

40. The method of claim 39, wherein the reused access point identifier comprises a physical cell identifier or pilot pseudorandom number identifier.

41. The method of claim 39, wherein:
the transmission from the first access point is based on a first identifier that uniquely identifies the first access point within a network; and
the transmission from the second access point is based on a second identifier that uniquely identifies the second access point within a network.

42. The method of claim 41, wherein:
the transmission from the first access point is pseudorandomly based on the first identifier; and
the transmission from the second access point is pseudorandomly based on the second identifier.

43. The method of claim 41, wherein:
the first identifier comprises a global cell identifier, an access node identifier, or a sector identifier; and
the second identifier comprises a global cell identifier, an access node identifier, or a sector identifier.

44. The method of claim 41, wherein:
the detection of the transmission from the first access point comprises detecting a signal on a first resource that results from the first access point electing to transmit on the first resource based on the first identifier; and
the detection of the transmission from the second access point comprises detecting a signal on a second resource that results from the second access point electing to transmit on the second resource based on the second identifier.

45. The method of claim 44, wherein:
the election by the first access point is pseudorandomly based on the first identifier; and
the election by the second access point is pseudorandomly based on the second identifier.

46. The method of claim 44, wherein the signal transmitted on the first resource comprises an indication of the first identifier and the signal transmitted on the second resource comprises an indication of the second identifier.

47. The method of claim 44, wherein the first and second resources comprises at least one of the group consisting of: a set of frames, a set of low reuse preambles, a set of time division multiplexed resources, and a set of frequency division multiplexed resources.

48. The method of claim 41, wherein:
the detection of the transmission from the first access point comprises using a first channelization to detect a signal that results from the first access point electing, based on the first identifier, to transmit using a first channelization parameter; and
the detection of the transmission from the second access point comprises using a second channelization to detect a signal that results from the second access point electing, based on the second identifier, to transmit using a second channelization parameter.

49. The method of claim 48, wherein:
the election by the first access point is pseudorandomly based on the first identifier; and
the election by the second access point is pseudorandomly based on the second identifier.

50. The method of claim 48, wherein:
the first channelization parameter comprises a combination of the reused access point identifier and at least one bit that is defined based on the first identifier; and
the second channelization parameter comprises a combination of the reused access point identifier and at least one bit that is defined based on the second identifier.

51. The method of claim 39, further comprising transmitting an indication of the collision to cause the first access point to cease transmitting on at least one resource, wherein the indication identifies the first access point.

52. The method of claim 51, further comprising, after the first access point ceases transmitting on the at least one resource, transmitting an identifier of at least one of the first and second access points to the second access point.

53. The method of claim 51, wherein the indication is transmitted on at least one channel that is reserved for collision reporting.

54. An apparatus for wireless communication, comprising:
a receiver configured to detect a transmission from a first access point that is channelized based on a reused access point identifier, and further configured to detect a transmission from a second access point that is channelized based on the reused access point identifier; and
a collision identifier configured to identify a collision based on the detections of the transmissions.

55. The apparatus of claim 54, wherein:
the transmission from the first access point is based on a first identifier that uniquely identifies the first access point within a network; and
the transmission from the second access point is based on a second identifier that uniquely identifies the second access point within a network.

56. The apparatus of claim 55, wherein:
the transmission from the first access point is pseudorandomly based on the first identifier; and
the transmission from the second access point is pseudorandomly based on the second identifier.

57. The apparatus of claim 55, wherein:
the detection of the transmission from the first access point comprises detecting a signal on a first resource that results from the first access point electing to transmit on the first resource based on the first identifier; and
the detection of the transmission from the second access point comprises detecting a signal on a second resource that results from the second access point electing to transmit on the second resource based on the second identifier.

58. The apparatus of claim 57, wherein the signal transmitted on the first resource comprises an indication of the first identifier and the signal transmitted on the second resource comprises an indication of the second identifier.

59. The apparatus of claim 55, wherein:
the detection of the transmission from the first access point comprises using a first channelization to detect a signal that results from the first access point electing, based on the first identifier, to transmit using a first channelization parameter; and
the detection of the transmission from the second access point comprises using a second channelization to detect a signal that results from the second access point electing, based on the second identifier, to transmit using a second channelization parameter.

60. The apparatus of claim 59, wherein:
the first channelization parameter comprises a combination of the reused access point identifier and at least one bit that is defined based on the first identifier; and
the second channelization parameter comprises a combination of the reused access point identifier and at least one bit that is defined based on the second identifier.

61. The apparatus of claim 54, further comprising a transmitter configured to transmit an indication of the collision to cause the first access point to cease transmitting on at least one resource, wherein:
the indication identifies the first access point; and
the transmitter transmits the indication on at least one channel that is reserved for collision reporting.

62. An apparatus for wireless communication, comprising:
means for detecting a transmission from a first access point that is channelized based on a reused access point identifier and for detecting a transmission from a second access point that is channelized based on the reused access point identifier; and
means for identifying a collision based on the detections of the transmissions.

63. The apparatus of claim 62, wherein:
the transmission from the first access point is based on a first identifier that uniquely identifies the first access point within a network; and
the transmission from the second access point is based on a second identifier that uniquely identifies the second access point within a network.

64. The apparatus of claim 63, wherein:
the transmission from the first access point is pseudorandomly based on the first identifier; and
the transmission from the second access point is pseudorandomly based on the second identifier.

65. The apparatus of claim 63, wherein:
the detection of the transmission from the first access point comprises detecting a signal on a first resource that results from the first access point electing to transmit on the first resource based on the first identifier; and
the detection of the transmission from the second access point comprises detecting a signal on a second resource that results from the second access point electing to transmit on the second resource based on the second identifier.

66. The apparatus of claim 65, wherein the signal transmitted on the first resource comprises an indication of the first identifier and the signal transmitted on the second resource comprises an indication of the second identifier.

67. The apparatus of claim 63, wherein:
the detection of the transmission from the first access point comprises using a first channelization to detect a signal that results from the first access point electing, based on the first identifier, to transmit using a first channelization parameter; and
the detection of the transmission from the second access point comprises using a second channelization to detect a signal that results from the second access point electing, based on the second identifier, to transmit using a second channelization parameter.

68. The apparatus of claim 67, wherein:
the first channelization parameter comprises a combination of the reused access point identifier and at least one bit that is defined based on the first identifier; and
the second channelization parameter comprises a combination of the reused access point identifier and at least one bit that is defined based on the second identifier.

69. The apparatus of claim 62, further comprising means for transmitting an indication of the collision to cause the first access point to cease transmitting on at least one resource, wherein:
the indication identifies the first access point; and
the means for transmitting transmits the indication on at least one channel that is reserved for collision reporting.

70. A computer-program product, comprising:
computer-readable medium comprising codes for causing a computer to:
detect a transmission from a first access point that is channelized based on a reused access point identifier;
detect a transmission from a second access point that is channelized based on the reused access point identifier; and
identify a collision based on the detections of the transmissions.

71. The computer-program product of claim 70, wherein:
the transmission from the first access point is based on a first identifier that uniquely identifies the first access point within a network; and
the transmission from the second access point is based on a second identifier that uniquely identifies the second access point within a network.

72. The computer-program product of claim 71, wherein:
the transmission from the first access point is pseudorandomly based on the first identifier; and
the transmission from the second access point is pseudorandomly based on the second identifier.

73. The computer-program product of claim 71, wherein:
the detection of the transmission from the first access point comprises detecting a signal on a first resource that results from the first access point electing to transmit on the first resource based on the first identifier; and
the detection of the transmission from the second access point comprises detecting a signal on a second resource that results from the second access point electing to transmit on the second resource based on the second identifier.

74. The computer-program product of claim 71, wherein:
the detection of the transmission from the first access point comprises using a first channelization to detect a signal that results from the first access point electing, based on the first identifier, to transmit using a first channelization parameter; and
the detection of the transmission from the second access point comprises using a second channelization to detect a signal that results from the second access point electing, based on the second identifier, to transmit using a second channelization parameter.
